(19) United States
(12) Patent Application Publication
(10) Pub. No.: US 2013/0189613 A1
(43) Pub. Date: Jul. 25, 2013

(54) METAL COMPLEX PIGMENT-CONTAINING TONER FOR ELECTROPHOTOGRAPHY AND METHOD FOR PRODUCING THE SAME

(71) Applicants: Kabushiki Kaisha Toshiba, Tokyo (JP); Toshiba Tec Kabushiki Kaisha, Tokyo (JP)

(72) Inventor: Satoshi Araki, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/737,108

(22) Filed: Jan. 9, 2013

Related U.S. Application Data
(60) Provisional application No. 61/588,763, filed on Jan. 20, 2012.

(51) Int. Cl. G03G 9/09

(52) U.S. Cl. CPC G03G 9/0918
USPC 430/108.21; 430/137.14

(57) ABSTRACT

Disclosed is a metal complex pigment-containing toner, wherein a pigment dispersion index (A) determined as a standard deviation of an X-ray fluorescence intensity, per unit area of toner particle surface, of a central metal of the metal complex pigment contained in the toner is less than 2 [cps/(KeV·μm²)], and a pigment surface dispersion index (B) obtained by dividing an average value of the X-ray fluorescence intensity by an X-ray fluorescence intensity of the central metal of the metal complex pigment in the entire composition of the toner as measured by an X-ray fluorescence analysis for analyzing deep internal regions is more than 0.027 [cps/(KeV·μm²·kcps)]. In this toner, the pigment is moderately dispersed on the surface side of the toner particles uniformly at a high concentration, and therefore, the coloring power thereof is improved.

### CROSS-REFERENCE TO RELATED APPLICATIONS

This application is based upon and claims the benefit of priority from U.S. Provisional Application No. 61/588,763 filed on Jan. 20, 2012; the entire contents of which are incorporated herein by reference.

### FIELD

Embodiments described herein relate generally to a toner for electrophotography in which the dispersibility and coloring power of a pigment to be contained are improved and a method for producing the same.

### BACKGROUND

In recent years, the demand for an increase in image quality, a reduction in power consumption, etc. in the marketplace is increasing more and more, and in order to meet the demand, studies are being performed for reducing the particle diameter of a toner and enhancing the coloring power thereof. In order to enhance the coloring power, studies are being performed mainly by increasing the concentration of a pigment or improving the dispersibility of a pigment.

However, an increase in the concentration of a pigment deteriorates the chargeability or color reproducibility and leads to an increase in the cost of toner. In a toner prepared by a pulverization method, the dispersibility of a pigment can be made favorable, but it is not easy to selectively dispose a pigment in the vicinity of the surface of the toner from the viewpoint of the production process, and therefore, it is not easy to obtain a toner having a high coloring power by a pulverization method.

### DETAILED DESCRIPTION

According to one embodiment, a toner for electrophotography in which the dispersibility and coloring power of a pigment to be contained are improved can be produced.

According to one embodiment, a metal complex pigment-containing toner, which is a toner containing a binder resin and a metal complex pigment dispersed in the binder resin, wherein a pigment dispersion index (A) determined as a standard deviation of an X-ray fluorescence intensity (1), per unit area of toner particle surface, of a central metal of the contained metal complex pigment as determined by an X-ray fluorescence analysis for analyzing surface regions is less than 2 [cps/(KeV·μm²)], and a pigment surface dispersion index (B) obtained by dividing an average value of the X-ray fluorescence intensity (1) by an X-ray fluorescence intensity of the central metal of the metal complex pigment in the entire composition of the toner as measured by an X-ray fluorescence analysis for analyzing deep internal regions is more than 0.027 [cps/(KeV·μm²·kcps)] is provided.

According to another embodiment, a method for producing a metal complex pigment-containing toner, including: preparing two types of dispersion liquids obtained by adding a metal complex pigment to a binder resin to disperse the metal complex pigment therein at a different concentration; subjecting the dispersion liquid having a low pigment concentration to aggregation; and then, subjecting the dispersion liquid having a high pigment concentration to aggregation is provided.

According to the above configuration, the dispersibility of the pigment is favorable and also the pigment is disposed in the vicinity of the surface of the toner, and therefore, a toner having a high coloring power can be obtained.

As the binder resin which can be used in the present embodiment, in order to obtain excellent translucency and color reproducibility as a full-color toner, a resin having a specific melting property is preferably used. Further, it is preferred to use a binder resin having a softening point of from 90 to 115° C. from the viewpoint of fixability. The type of the resin is not particularly limited as long as the binder resin has the above-described properties, and for example, a styrene-acrylic copolymer resin, a polyester resin, an epoxy resin, or the like can be used, and these resins can be used alone or in admixture. Among these resins, a polyester resin is particularly preferred.

In the present embodiment, a preferred polyester resin is one synthesized by a polycondensation reaction using an alkylene oxide adduct of bisphenol A as a principal component of an alcohol component and also using a phthalic acid-based dicarboxylic acid or a phthalic acid-based dicarboxylic acid and an aliphatic dicarboxylic acid as acid components.

The metal complex pigment which is preferably used in the present embodiment is a metal complex pigment having, as a central element, a transition metal which can be quantitatively determined by an X-ray fluorescence analysis such as Cu, Fe, Zn, Co, Cr, Ni, or Pd, and among these, a phthalocyanine pigment (generally having a color of blue to green) which has a phthalocyanine skeleton as a ligand and has any of the above-described transition metals as a central element is preferred. In the case of a toner for electrophotography, generally, such a phthalocyanine pigment is preferably used for forming a cyan toner. Above all, copper phthalocyanine having Cu as a central element (such as phthalocyanine blue B and C.I. Pigment Blue 15), a chlorine-substituted compound thereof and a lake pigment thereof are representative examples thereof.

Further, the addition amount of such a metal complex pigment is not particularly limited, but is preferably from 4 to 15 parts by weight with respect to 100 parts by weight of the binder resin.

In the present embodiment, the metal complex pigment constitutes a principal component of the coloring agent constituting the toner, but does not prevent a combination use with another dye or pigment for the purpose of adjusting the color tone or other purposes. Further, in addition to the coloring agent containing the above-described metal complex pigment, a charge control agent can be appropriately used for controlling the chargeability of the toner to be obtained. Examples of the charge control agent include a zirconium complex salt TN-105 (manufactured by Hodogaya Chemical Co., Ltd.), chromium salicylate complex salts E-81 and E-82 (manufactured by Orient Chemical Industries Co., Ltd.), a zinc salicylate complex salt E-84 (manufactured by Orient Chemical Industries Co., Ltd.), an aluminum salicylate complex salt E-86 (manufactured by Orient Chemical Industries Co., Ltd.), a calixarene compound E-89 (manufactured by Orient Chemical Industries Co., Ltd.), and a boron benzilate complex salt.

Further, in addition to the above-described binder resin, a wax such as a low-molecular weight polypropylene wax, a low-molecular weight polyethylene wax, carnauba wax, or sasol wax may be added as needed for improving the offset resistance, or in the case of a non-magnetic mono-component toner, for preventing the adhesion of the toner to a regulating blade or a developing roller of a developing device.

A metallic soap to be used for the same purpose is formed from a simple fatty acid (such as caprylic acid, capric acid, lauric acid, myristic acid, myristoleic acid, palmitic acid, isopalmitic acid, palmitoleic acid, stearic acid, behenic acid, lignoceric acid, cerotic acid, montanic acid, isostearic acid, oleic acid, arachic acid, ricinoleic acid, linoleic acid, behenic acid, or erucic acid) or a saturated or unsaturated fatty acid having 4 or more carbon atoms (represented by a fatty acid derived from an animal or vegetable fat or oil such as a beef tallow fatty acid, a soybean oil fatty acid, a coconut oil fatty acid, or a palm oil fatty acid) and an alkaline earth metal (such as calcium, barium, or magnesium), or another metal (such as titanium, zinc, copper, manganese, cadmium, mercury, zirconium, lead, iron, aluminum, cobalt, nickel, or silver). In particular, a Ca salt, a Zn salt, or a Ba salt of a saturated or unsaturated fatty acid having 10 to 24 carbon atoms, preferably, 12 to 22 carbon atoms, or the like is preferred. In particular, a Ca salt, a Zn salt, or a Ba salt of a saturated or unsaturated fatty acid having 14 to 22 carbon atoms or the like is preferred. Among these metallic soaps, one type may be used or two or more types may be used in admixture.

In the present embodiment, it is preferred to prepare toner (mother) particles by a chemical production method including an aggregation step, such as a suspension polymerization method, an emulsion aggregation method, or a solution suspension method.

Further, a method in which a particulate mixture containing the binder resin and the coloring agent containing the metal complex pigment as a principal component is mixed with an aqueous medium to form a dispersion liquid of the mixture, and a mechanical shearing force is applied to the obtained dispersion liquid of the mixture to finely pulverize the mixture in the dispersion liquid, and then, the finely pulverized mixture is aggregated and fused to prepare toner particles is also preferably used.

Specifically, the preparation can be performed, for example, as follows.

First, the constituent components (toner materials) containing the binder resin and the coloring agent are kneaded using a twin-screw kneader or the like, and the resulting kneaded material is crushed, whereby coarsely crushed particulate mixtures A (with a low coloring agent concentration) and B (with a high coloring agent concentration), containing the coloring agent (metal complex pigment) at different concentrations are obtained. The ratio of the concentration of the coloring agent in the mixture A to the concentration the coloring agent in the mixture B is preferably within a range of from 1:1.5 to 1:4. If the ratio is outside the range, a desired pigment dispersion index (A) and a desired pigment surface dispersion index (B), that is, a desired pigment dispersion state and a desired coloring power are hard to obtain. Further, the ratio of the amount of the mixture (A) to the amount of the mixture (B) constituting the toner is preferably within a range of from 1:0.5 to 1:0.9.

To each of these coarsely crushed mixtures A and B, an aqueous medium such as water or a mixture of water and an organic solvent miscible with water is added, whereby dispersion liquids A and B containing the mixtures A and B, respectively, are prepared. The aqueous medium may contain at least one of a surfactant and a basic compound.

The surfactant is not particularly limited, but examples thereof include anionic surfactants such as sulfate ester salt-based, sulfonate salt-based, phosphate ester-based, and soap-based anionic surfactants; cationic surfactants such as amine salt-based and quaternary ammonium salt-based cationic surfactants; and nonionic surfactants such as polyethylene glycol-based, alkyl phenol ethylene oxide adduct-based, and polyhydric alcohol-based nonionic surfactants.

As the basic compound, an amine compound can be exemplified, and for example, dimethylamine, trimethylamine, monoethylamine, diethylamine, triethylamine, propylamine, isopropylamine, dipropylamine, butylamine, isobutylamine, sec-butylamine, monoethanolamine, diethanolamine, triethanolamine, triisopropanolamine, isopropanolamine, dimethylethanolamine, diethylethanolamine, N-butyldiethanolamine, N,N-dimethyl-1,3-diaminopropane, N,N-diethyl-1,3-diaminopropane and the like can be used. The basic compound acts as, for example, a dispersing aid.

To this toner material dispersion liquid, a mechanical shearing force is applied to finely pulverize the material until the 50% volume average diameter (a particle diameter, which gives a cumulative value of 50% on the basis of a particle size distribution as measured by a laser diffraction type particle size distribution measuring device) of the dispersed particles is decreased to 0.01 to 1 μm.

Examples of the mechanical shearing device which can be used for applying a mechanical shearing force include mechanical shearing devices, which do not use media, such as Ultra Turrax (manufactured by IKA Japan K.K.), T.K. Auto Homo Mixer (manufactured by Primix Corporation), T.K. Pipeline Homo Mixer (manufactured by Primix Corporation), T.K. Filmix (manufactured by Primix Corporation), Clear mix (manufactured by M-Technique Co., Ltd.), Clear SS5 (manufactured by M-Technique Co., Ltd.), Cavitron (manufactured by Eurotec, Ltd.), Fine Flow Mill (manufactured by Pacific Machinery & Engineering Co., Ltd.), Microfluidizer (manufactured by Mizuho Industrial Co., Ltd.), Altimizer (manufactured by Sugino Machine, Ltd.), Nanomizer (manufactured by Yoshida Kikai Co. Ltd.), Genus PY (manufactured by Hakusui Chemical Industries Co., Ltd.), and NANO 3000 (manufactured by Beryu Co., Ltd.); and mechanical shearing devices, which use media, such as Visco mill (manufactured by Aimex Co., Ltd.), Apex mill (manufactured by Kotobuki Industries Co., Ltd.), Star Mill (manufactured by Ashizawa Finetech, Ltd.), DCP Super flow (manufactured by Nippon Eirich Co., Ltd.), MP Mill (manufactured by Inoue Manufacturing Co., Ltd.), Spike Mill (manufactured by Inoue Manufacturing Co., Ltd.), Mighty Mill (manufactured by Inoue Manufacturing Co., Ltd.), and SC Mill (manufactured by Mitsui Mining Co., Ltd.).

Subsequently, the dispersion liquids A and B, each containing the finely pulverized mixture are subjected to an aggregation and fusing step. Specifically, first, to the dispersion liquid A of particles containing the coloring agent at a low concentration, an aggregating agent is added, followed by heating, whereby the particles are aggregated until the particle diameter reaches 60 to 98% of the desired toner particle diameter. Then, the dispersion liquid B is added thereto, and the particles are further aggregated, whereby a dispersion liquid of aggregated particles is obtained. The type of the aggregating agent, the addition amount thereof, and the heating temperature can be appropriately set by those skilled in the art.

Examples of the aggregating agent include metal salts such as sodium chloride, calcium chloride, calcium nitrate, barium chloride, magnesium chloride, zinc chloride, magnesium sulfate, aluminum chloride, aluminum sulfate, and potassium aluminum sulfate; inorganic metal salt polymers such as polyaluminum chloride, polyaluminum hydroxide, and calcium polysulfide; polymeric aggregating agents such as polymethacrylic acid esters, polyacrylic acid esters, polyacrylamides, and acrylamide-sodium acrylate copolymers; coagulating agents such as polyamines, polydiallyl ammonium halides, melanin formaldehyde condensates, and dicyandiamide; alcohols such as methanol, ethanol, 1-propanol, 2-propanol, 2-methyl-2-propanol, 2-methoxyethanol, 2-ethoxyethanol, and 2-butoxyethanol; organic solvents such as acetonitrile and 1,4-dioxane; inorganic acids such as hydrochloric acid and nitric acid; and organic acids such as formic acid and acetic acid.

Subsequently, the fluidity of the binder resin is increased by heating, and the aggregated binder resin, coloring agent, and release agent are fused. The heating temperature in the fusing treatment can be appropriately set by those skilled in the art within a range not lower than the glass transition temperature of the binder resin and not higher than the boiling point of water under the pressure in the dispersion system.

Subsequently, the particles obtained by the fusing treatment are washed and dried, whereby toner particles having a 50% volume average diameter (on the basis of the particle size distribution measured by a Coulter counter having an aperture diameter of 100 μm) of from about 4 to 8 μm are prepared.

Further, in the present embodiment, in order to adjust the fluidity or chargeability of toner particles obtained through the above-described steps, inorganic fine particles may be mixed for external addition in an amount of from 0.2 to 3% by weight of the amount of the toner particles. As such inorganic fine particles, fine particles having an average particle diameter of from about 1 to 500 nm of, for example, silica, titania, alumina, strontium titanate, tin oxide, and the like can be exemplified, and a single type can be used or two or more types in admixture can be used. As the inorganic fine particles, it is preferred to use those surface-treated with a hydrophobizing agent from the viewpoint of improvement of environmental stability. Further, other than such inorganic oxides, resin fine particles having a size of 1 μm or less may be externally added for improving the cleaning property.

### EXAMPLES

Hereinafter, embodiments will be more specifically described with reference to Examples and Comparative Examples. The measurement of the physical properties described in this specification including the following description and the evaluation of toners obtained were performed by the following methods.

### [Measurement of Pigment Dispersion Index (A) and Pigment Surface Dispersion Index (B)]

The pigment dispersion index (A) and the pigment surface dispersion index (B), each of which characterizes the toner of the present embodiment, were determined by combining an X-ray fluorescence analysis for analyzing surface regions with an X-ray fluorescence analysis for analyzing deep internal regions and performing calculation as follows.

### <X-Ray Fluorescence Analysis for Analyzing Surface Regions>

(1) Carbon paste was attached to a sample stage, and then, a small amount (about 0.01 g) of a toner was dispersed thereon and attached thereto, followed by drying using a vacuum dryer. Then, a thin layer of Pt was deposited by vapor deposition, whereby a sample was prepared. Thereafter, the thus prepared sample was placed in an electron microscope (ULTRA 55, manufactured by Carl Zeiss Co., Ltd.), and 10 toner particles were arbitrarily selected and observation was performed under the following conditions: acceleration voltage: 7.5 kV, aperture diameter: 120 μm (high current mode), WD: 8 mm, and magnification: 20000×. Then, an elementary analysis of a region in a circle with a radius of 0.3 μm on the surface of the toner particle was performed by a hyper map analysis using an energy dispersive X-ray fluorescence spectrometer (EDX QX-400, manufactured by Bruker Co., Ltd.) attached to the electron microscope. The measurement of the X-ray fluorescence intensity (EDX intensity) of a central metal (a target metal, Cu in the following Examples) constituting the complex pigment was performed at 12 sites per toner particle, and an EDX intensity per unit area [cps/(KeV·μm²)] is calculated by dividing the measurement by an area in a specified range (0.09 μm²).

### (Measurement Conditions)

Accelerating voltage: 7.5 kV, Aperture diameter: 120 μm (high current mode), WD: 8 mm, magnification: 20000×, hyper throughput: automatic, maximum energy: 20 keV, mode: normal operation, cooling: thermostat

By this measurement, the EDX intensity in a region to a depth of about 1 μm from the surface of the toner particle is measured, and therefore, the concentration of the central metal is measured.

(2) A standard deviation (unit: cps/(KeV·μm²) of the 120 measurement values of the EDX intensity (1) per unit area obtained above is calculated as a pigment dispersion index (A).

### <X-Ray Fluorescence Analysis for Analyzing Deep Internal Regions>

(3) 5 g of a toner is separately weighed and placed in a molding machine with a radius of 2 cm. Subsequently, a pressure of 30 tons is applied thereto for 5 minutes to obtain a pellet-shaped sample. Then, for the obtained pellet-shaped sample, the X-ray fluorescence intensity of a target metal is measured using a wavelength dispersive X-ray fluorescence spectrometer (XRF-1800, manufactured by Shimadzu Corporation) for analyzing deep internal regions, and the X-ray fluorescence intensity [kcps] corresponding to the amount of the target metal in the toner is obtained.

### (Measurement Conditions)

Aperture: 30, X-ray tube target: Rh, filter: not used, slit: standard, attenuator: not used, crystal: LiF, detector: SC, PHA low level: 25, PHA high level: 75, goniometer: continuous, speed: 8 deg/min, step angle: 0.1 degree

By this measurement, the X-ray fluorescence intensity (XRF intensity of the entire toner) (unit: kcps) corresponding to the concentration of the target metal in a region at a depth of several tens micrometers of the pelletized sample, that is, in the entire composition of the sample toner is measured.

(4) A pigment surface dispersion index (B) is calculated by dividing the average value of the surface EDX intensity per unit area obtained in the above (1) by the X-ray fluorescence intensity corresponding to the amount of the target metal in the toner obtained in the above (3).

The toner obtained according to the present embodiment is characterized by satisfying the following formulae: the pigment dispersion index (A)<2, and the pigment surface dispersion index (B)>0.027. If the pigment dispersion index (A) is 2 or more or the pigment surface dispersion index (B) is 0.027 or less, the dispersibility of the pigment is deteriorated or the amount of the pigment in the surface of the toner required for effective coloring is decreased, and therefore, a favorable coloring power cannot be obtained.

### [Evaluation of Coloring Power]

In a developing device of an electrophotographic multifunction peripheral (e-studio 2050c, manufactured by Toshiba Tec Corporation) modified such that an unfixed image can be obtained, a developer obtained by mixing a sample toner with a magnetic carrier (manufactured by Powder Tech Co., Ltd.) having a volume average particle diameter of 50 μm in such an amount that the concentration of the toner was 8% by weight was placed, and a plurality of unfixed solid images were obtained while changing the setting of the concentration (i.e., the supply amount of the toner), and the unfixed solid images were fixed using an external fixation device which was set to 140° C. At this time, the weight of the sheet was measured in advance, and also the weight of the sheet having an unfixed solid image formed thereon was measured. Then, the weight of the sheet was subtracted from the weight of the sheet having an unfixed solid image formed thereon, whereby a toner deposition amount per unit area [mg/cm²] was calculated. Further, an image density of the fixed image was measured using a reflection densitometer (RD-19, manufactured by Macbeth, Inc.), and the toner deposition amount [mg/cm²] when the image density was 1.5 was obtained. A case where the toner deposition amount giving an image density of 1.5 was less than 0.3 mg/cm² was evaluated to be A, a case where the toner deposition amount giving an image density of 1.5 was 0.3 mg/cm² or more and less than 0.4 mg/cm² was evaluated to be B, and a case where the toner deposition amount giving an image density of 1.5 was 0.4 mg/cm² or more was evaluated to be C.

### Example 1

93 Parts by mass of a polyester resin, 3 parts by mass of a cyan pigment (copper phthalocyanine) as a coloring agent, 4 parts by mass of an ester wax, and 1 part by mass of a zirconia metal complex as a charge control agent were mixed, and the resulting mixture was melt-kneaded using a twin-screw kneader which was set to a temperature of 120° C., whereby a kneaded material A1 was obtained.

88 Parts by mass of a polyester resin, 7 parts by mass of a cyan pigment (copper phthalocyanine) as a coloring agent, 4 parts by mass of an ester wax, and 1 part by mass of a zirconia metal complex as a charge control agent were mixed, and the resulting mixture was melt-kneaded using a twin-screw kneader which was set to a temperature of 120° C., whereby a kneaded material B1 was obtained.

Each of the thus obtained kneaded materials A1 and B1 was coarsely crushed to a volume average particle diameter of 1.2 mm using a hammer mill manufactured by Nara Machinery Co., Ltd. Then, the obtained coarse particles were put into a bantam mill manufactured by Hosokawa Micron Corporation which was set to a rotational speed of 12000 rpm, whereby moderately crushed particles A1 and B1 were obtained.

Parts by mass of the moderately crushed particles A1, 2 parts by mass of sodium dodecylbenzene sulfonate and 2 parts by mass of a sodium salt of a copolymer of acrylic acid and maleic acid as dispersing agents, 2 parts by mass of triethylamine as a dispersing aid, and 65 parts by mass of ion exchanged water were preliminarily dispersed using ULTRA TURRAX T50 manufactured by IKA Japan K.K., whereby a preliminary dispersion liquid A1 was obtained.

Further, the moderately crushed particles B1 were also subjected to a treatment in the same manner as in the case of A1 described above, whereby a preliminary dispersion liquid B1 was obtained.

The thus obtained preliminary dispersion liquid A1 was put into a Nanomizer (manufactured by Yoshida Kikai Co. Ltd., YSNM-2000AR additionally having a heating system). The temperature of the heating system was set to 160° C., and the processing pressure of the Nanomizer was set to 160 MPa. A finely pulverizing treatment was performed by repeating the processing of the dispersion liquid by the Nanomizer three times, whereby a fine particle dispersion liquid A1 was obtained. Further, the preliminary dispersion liquid B1 was also subjected to the same treatment, whereby a fine particle dispersion liquid B1 was obtained.

2 Parts by mass of aluminum sulfate was added to 60 parts by mass of the fine particle dispersion liquid A1 while maintaining the dispersion liquid at 40° C., and then, the temperature of the mixture was raised to 55° C. to aggregate the fine particles to a desired volume average particle diameter. Then, further 40 parts by mass of the fine particle dispersion liquid B1 was added thereto, and the temperature of the mixture was maintained at 55° C. to complete aggregation (encapsulation), whereby an aggregated particle dispersion liquid was obtained. Thereafter, as a dispersion stabilizing agent, 4 parts by mass of a sodium salt of a copolymer of acrylic acid and maleic acid was added thereto, and then, the temperature of the mixture was raised to 90° C. and the mixture was left as such for 3 hours, whereby a fused particle dispersion liquid was obtained.

After the thus obtained fused particle dispersion liquid was subjected to solid-liquid separation, as a washing water, 600 mL of ion exchanged water was added to the resulting solid to effect washing. Thereafter, the thus obtained solid was dried using a vacuum dryer, whereby toner particles having a volume average particle diameter of 4.8 μm were obtained.

To 100 parts by mass the thus obtained toner particles, 3 parts by mass of silica fine particles having a volume average particle diameter of 30 nm and 1.5 parts by mass of titanium fine particles having a volume average particle diameter of 30 nm were added, and mixing was performed using Henschel mixer to effect external addition, followed by sieving through an ultrasonic vibrating sieve, whereby a toner was obtained.

The pigment dispersion index (A) and the pigment surface dispersion index (B) of the thus obtained toner were measured as described above, and found to be (A)=1.75 and (B)=0.028. Further, the coloring power of the toner was evaluated to be A.

### Example 2

93 Parts by mass of a polyester resin, 2 parts by mass of a cyan pigment (copper phthalocyanine) as a coloring agent, 4 parts by mass of an ester wax, and 1 part by mass of a zirconia metal complex as a charge control agent were mixed, and the resulting mixture was melt-kneaded using a twin-screw kneader which was set to a temperature of 120° C., whereby a kneaded material A2 was obtained.

87 Parts by mass of a polyester resin, 8 parts by mass of a cyan pigment (copper phthalocyanine) as a coloring agent, 4 parts by mass of an ester wax, and 1 part by mass of a zirconia metal complex as a charge control agent were mixed, and the resulting mixture was melt-kneaded using a twin-screw kneader which was set to a temperature of 120° C., whereby a kneaded material B2 was obtained.

Each of the thus obtained kneaded materials A2 and B2 was coarsely crushed to a volume average particle diameter of 1.2 mm using a hammer mill manufactured by Nara Machinery Co., Ltd. Then, the obtained coarse particles were put into a bantam mill manufactured by Hosokawa Micron Corporation which was set to a rotational speed of 12000 rpm, whereby moderately crushed particles A2 and B2 were obtained.

Parts by mass of the moderately crushed particles A2, 2 parts by mass of sodium dodecylbenzene sulfonate and 2 parts by mass of a sodium salt of a copolymer of acrylic acid and maleic acid as dispersing agents, 2 parts by mass of triethylamine as a dispersing aid, and 65 parts by mass of ion exchanged water were preliminarily dispersed using ULTRA TURRAX T50 manufactured by TKA Japan K.K., whereby a preliminary dispersion liquid A2 was obtained. Further, the moderately crushed particles 32 were also subjected to the same treatment, whereby a preliminary dispersion liquid B2 was obtained.

The thus obtained preliminary dispersion liquid A2 was put into a Nanomizer (manufactured by Yoshida Kikai Co. Ltd., YSNM-2000AR additionally having a heating system). The temperature of the heating system was set to 160° C., and the processing pressure of the Nanomizer was set to 160 MPa. The processing of the dispersion liquid by the Nanomizer was repeated three times, whereby a dispersion liquid A2 was obtained. Further, the preliminary dispersion liquid B2 was also subjected to the same treatment, whereby a dispersion liquid B2 was obtained.

2 Parts by mass of aluminum sulfate was added to 55 parts by mass of the dispersion liquid A2 while maintaining the dispersion liquid at 40° C., and then, the temperature of the mixture was raised to 55° C. to aggregate the fine particles to a desired volume average particle diameter. Then, further 45 parts by mass of the dispersion liquid B2 was added thereto, and the temperature of the mixture was maintained at 55° C. to complete aggregation (encapsulation), whereby an aggregated particle dispersion liquid was obtained. Thereafter, as a dispersion stabilizing agent, 4 parts by mass of a sodium salt of a copolymer of acrylic acid and maleic acid was added thereto, and then, the temperature of the mixture was raised to 90° C. and the mixture was left as such for 3 hours, whereby a fused particle dispersion liquid was obtained.

After the thus obtained fused particle dispersion liquid was subjected to solid-liquid separation, as a washing water, 600 mL of ion exchanged water was added to the resulting solid to effect washing. Thereafter, the thus obtained solid was dried using a vacuum dryer, whereby toner particles having a volume average particle diameter of 5.2 μm were obtained.

In the same manner as in Example 1, to 100 parts by mass of the thus obtained toner particles, 3 parts by mass of silica fine particles and 1.5 parts by mass of titanium fine particles were added, and mixing was performed using Henschel mixer to effect external addition, followed by sieving through an ultrasonic vibrating sieve, whereby a toner was obtained.

The pigment dispersion index (A) and the pigment surface dispersion index (B) of the thus obtained toner were measured as described above, and found to be (A)=1.92 and (B)=0.035. Further, the coloring power of the toner was evaluated to be A.

### Comparative Example 1

2 Parts by mass of aluminum sulfate was added to 40 parts by mass of the dispersion liquid B1 while maintaining the dispersion liquid at 40° C., and then, the temperature of the mixture was raised to 55° C. to aggregate the fine particles to a desired volume average particle diameter. Then, further 60 parts by mass of the dispersion liquid A1 was added thereto, and the temperature of the mixture was maintained at 55° C. to complete aggregation (encapsulation), whereby an aggregated particle dispersion liquid was obtained. The same processing as in Example 1 was performed except for the above-described processing, whereby a toner containing toner particles having a volume average particle diameter of about 4.5 μm was obtained.

The pigment dispersion index (A) and the pigment surface dispersion index (B) of the thus obtained toner were measured as described above, and found to be (A)=1.83 and (B)=0.023. Further, the coloring power of the toner was evaluated to be B.

### Comparative Example 2

94 Parts by mass of a polyester resin, 1 part by mass of a cyan pigment (copper phthalocyanine) as a coloring agent, 4 parts by mass of an ester wax, and 1 part by mass of a zirconia metal complex as a charge control agent were mixed, and the resulting mixture was melt-kneaded using a twin-screw kneader which was set to a temperature of 120° C., whereby a kneaded material A3 was obtained.

86 Parts by mass of a polyester resin, 9 parts by mass of a cyan pigment (copper phthalocyanine) as a coloring agent, 4 parts by mass of an ester wax, and 1 part by mass of a zirconia metal complex as a charge control agent were mixed, and the resulting mixture was melt-kneaded using a twin-screw kneader which was set to a temperature of 120° C., whereby a kneaded material B3 was obtained.

Each of the thus obtained kneaded materials A3 and B3 was coarsely crushed to a volume average particle diameter of 1.2 mm using a hammer mill manufactured by Nara Machinery Co., Ltd. Then, the obtained coarse particles were put into a bantam mill manufactured by Hosokawa Micron Corporation which was set to a rotational speed of 12000 rpm, whereby moderately crushed particles A3 and B3 were obtained.

30 Parts by mass of the moderately crushed particles A3, 2 parts by mass of sodium dodecylbenzene sulfonate and 2 parts by mass of a sodium salt of a copolymer of acrylic acid and maleic acid as dispersing agents, 2 parts by mass of triethylamine as a dispersing aid, and 65 parts by mass of ion exchanged water were preliminarily dispersed using ULTRA TURRAX T50 manufactured by IKA Japan K.K., whereby a preliminary dispersion liquid A3 was obtained. Further, the moderately crushed particles B3 were also subjected to the same treatment, whereby a preliminary dispersion liquid B3 was obtained.

The thus obtained preliminary dispersion liquid A3 was put into a Nanomizer (manufactured by Yoshida Kikai Co. Ltd., YSNM-2000AR additionally having a heating system). The temperature of the heating system was set to 160° C., and the processing pressure of the Nanomizer was set to 160 MPa. The processing of the dispersion liquid by the Nanomizer was repeated three times, whereby a dispersion liquid A3 was obtained. Further, the preliminary dispersion liquid B3 was also subjected to the same treatment, whereby a dispersion liquid B3 was obtained.

2 Parts by mass of aluminum sulfate was added to 55 parts by mass of the dispersion liquid A3 while maintaining the dispersion liquid at 40° C., and then, the temperature of the mixture was raised to 55° C. to aggregate the fine particles to a desired volume average particle diameter. Then, further 45 parts by mass of the dispersion liquid B3 was added thereto, and the temperature of the mixture was maintained at 55° C. to complete aggregation (encapsulation), whereby an aggregated particle dispersion liquid was obtained. Thereafter, as a dispersion stabilizing agent, 4 parts by mass of a sodium salt of a copolymer of acrylic acid and maleic acid was added thereto, and then, the temperature of the mixture was raised to 90° C. and the mixture was left as such for 3 hours, whereby a fused particle dispersion liquid was obtained.

After the thus obtained fused particle dispersion liquid was subjected to solid-liquid separation, as a washing water, 600 mL of ion exchanged water was added to the resulting solid to effect washing. Thereafter, the thus obtained solid was dried using a vacuum dryer, whereby toner particles having a volume average particle diameter of 5.0 μm were obtained.

In the same manner as in Example 1, to 100 parts by mass of the thus obtained toner particles, 3 parts by mass of silica fine particles and 1.5 parts by mass of titanium fine particles were added, and mixing was performed using Henschel mixer to effect external addition, followed by sieving through an ultrasonic vibrating sieve, whereby a toner was obtained.

The pigment dispersion index (A) and the pigment surface dispersion index (B) of the thus obtained toner were measured as described above, and found to be (A)=2.03 and (B)=0.042. Further, the coloring power of the toner was evaluated to be C.

### Comparative Example 3

90 Parts by mass of a polyester resin, 5 parts by mass of a cyan pigment (copper phthalocyanine) as a coloring agent, 4 parts by mass of an ester wax, and 1 part by mass of a zirconia metal complex as a charge control agent were mixed, and the resulting mixture was melt-kneaded using a twin-screw kneader which was set to a temperature of 120° C., whereby a kneaded material g was obtained.

The thus obtained kneaded material was coarsely crushed using a feather mill and then crushed using a jet mill. Then, the crushed material was classified using a rotor classifier, whereby toner particles having a volume average particle diameter of 5.3 μm were obtained.

In the same manner as in Example 1, to 100 parts by mass of the thus obtained toner particles, 3 parts by mass of silica fine particles and 1.5 parts by mass of titanium fine particles were added, and mixing was performed using Henschel mixer to effect external addition, followed by sieving through an ultrasonic vibrating sieve, whereby a toner was obtained.

The pigment dispersion index (A) and the pigment surface dispersion index (B) of the thus obtained toner were measured as described above, and found to be (A)=1.73 and (B)=0.026. Further, the coloring power of the toner was evaluated to be B.

TABLE 1

| | EDX | | XRF | Pigment | |
|---|---|---|---|---|---|
| | intensity | Pigment | intensity | surface | Evaluation |
| | [cps/ | dispersion | of entire | dispersion | of |
| | (KeV · | index | toner | index | coloring |
| | μm²)] | (A) | (kcps) | (B) | power |
| Example 1 | 6.5 | 1.75 | 233 | 0.028 | A |
| Example 2 | 8.4 | 1.92 | 240 | 0.035 | A |
| Comparative | 5.5 | 1.83 | 237 | 0.023 | B |
| Example 1 | | | | | |
| Comparative | 10.2 | 2.03 | 242 | 0.042 | C |
| Example 2 | | | | | |
| Comparative | 6.6 | 1.73 | 255 | 0.026 | B |
| Example 3 | | | | | |

As apparent from the results shown in the above Table 1, the concentration of the pigment in the entire toner is substantially the same among the toners of Examples and Comparative Examples (there is almost no difference in the XRF intensity of the entire toner). However, it is found that since in the toners of Examples 1 and 2 which satisfy the following formulae: the pigment dispersion index (A)<2, and the pigment surface dispersion index (B)>0.027, the pigment is moderately dispersed on the surface side of the toner particles uniformly at a high concentration, and therefore, the coloring power thereof is improved. On the other hand, in the case of the toner of Comparative Example 1 in which the pigment is incorporated at a high concentration rather on the inner side of the toner particles and in the case of the toner of Comparative Example 3 in which the pigment is incorporated at a uniform concentration on the inner side and the surface side of the toner particles (a simple pulverization method), the coloring power thereof is lower than that of the toners of Examples (the coloring power is not improved). Meanwhile, in the case of the toner of Comparative Example 2 in which the ratio of the concentration of the pigment on the inner side to the concentration the pigment on the surface side is extremely increased, as indicated by the following formula: the pigment dispersion index (A)>2, the dispersibility of the pigment is poor, and therefore, the coloring power is decreased instead.

While certain embodiments have been described, these embodiments have been presented by way of example only, and are not intended to limit the scope of the inventions. Indeed the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A metal complex pigment-containing toner, comprising a binder resin and a metal complex pigment dispersed in the binder resin, wherein a pigment dispersion index (A) determined as a standard deviation of an X-ray fluorescence intensity (1), per unit area of toner particle surface, of a central metal of the contained metal complex pigment as determined by an X-ray fluorescence analysis for analyzing surface regions is less than 2 [cps/(KeV·μm²)], and a pigment surface dispersion index (B) obtained by dividing an average value of the X-ray fluorescence intensity (1) by an X-ray fluorescence intensity of the central metal of the metal complex pigment in the entire composition of the toner as measured by an X-ray fluorescence analysis for analyzing deep internal regions is more than 0.027 [cps/(KeV·μm²·kcps)].

2. The toner according to claim 1, wherein the metal complex pigment is a phthalocyanine pigment.

3. The toner according to claim 1, wherein the metal complex pigment is a copper(II) phthalocyanine pigment.

4. A method for producing a metal complex pigment-containing toner, comprising:
separately preparing dispersion liquids of two types of particles obtained by adding a metal complex pigment to a binder resin to disperse the metal complex pigment therein at a different concentration;
subjecting the dispersion liquid of particles having a low pigment concentration to aggregation; and then,
subjecting the dispersion liquid of particles having a high pigment concentration to aggregation.

5. The method according to claim 4, wherein the ratio of the concentration of the pigment in the particles having a low pigment concentration to the concentration of the pigment in the particles having a high pigment concentration is in a range of from 1:1.5 to 1:4.

6. The method according to claim 4, wherein the mass ratio of the particles having a low pigment concentration to the particles having a high pigment concentration is in a range of from 1:0.5 to 1:0.9.

7. The method according to claim 5, wherein the mass ratio of the particles having a low pigment concentration to the particles having a high pigment concentration is in a range of from 1:0.5 to 1:0.9.

8. The method according to claim 4, wherein the metal complex pigment is a phthalocyanine pigment.

9. The method according to claim 4, wherein the metal complex pigment is a copper(II) phthalocyanine pigment.
